(19) United States
(12) Patent Application Publication
(10) Pub. No.: US 2010/0177695 A1
(43) Pub. Date: Jul. 15, 2010

(54) TECHNIQUE FOR INTERFERENCE MITIGATION USING MOBILE STATION SIGNALING

(75) Inventors: Baowei JI, Plano, TX (US); Farooq KHAN, Allen, TX (US)

Correspondence Address: Jefferson IP Law, LLP, 1130 Connecticut Ave., NW, Suite 420, Washington, DC, 20036, US

(73) Assignee: Samsung Electronics Co., Ltd., Suwon-si (KR)

(21) Appl. No.: 12/635,687

(22) Filed: Dec. 10, 2009

Related U.S. Application Data
(60) Provisional application No. 61/204,860, filed on Jan. 12, 2009.
(60) Provisional application No. 61/204,692, filed on Jan. 9, 2009.

(51) Int. Cl. H04W 4/00; H04B 1/00

(52) U.S. Cl. 370/328; 455/63.1

(57) ABSTRACT

A Mobile Station (MS) and a Closed Subscriber Group (CSG) Femtocell Base Station (FBS) for Interference Mitigation (IM) in a wireless communication system, and methods for their operation, are provided. A method for operating the MS includes determining if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from, and if it is determined that the MS cannot access the first CSG FBS due to interference received from the second CSG FBS, transmitting an IM-Signal to the second CSG FBS requesting that the second CSG FBS mitigate the interference to the MS.

### CROSS-REFERENCE TO RELATED APPLICATIONS

This application claims the benefit under 35 U.S.C. §119(e) of a U.S. Provisional application filed on Jan. 9, 2009 in the U.S. Patent and Trademark Office and assigned Ser. No. 61/204,692, and a U.S. Provisional application filed on Jan. 12, 2009 in the U.S. Patent and Trademark Office and assigned Ser. No. 61/204,860, the entire disclosures of each of which are hereby incorporated by reference.

### BACKGROUND OF THE INVENTION

1. Field of the Invention

The present invention relates to interference mitigation in a wireless communication system. More particularly, the present invention relates to a technique for interference mitigation using Mobile Station (MS) signaling in a wireless communication system.

2. Description of the Related Art

In a wireless communication system, a channel may deteriorate due to a number of factors, including a geographical factor inside a cell, a distance between a Mobile Station (MS) and a Base Station (BS), movement of the MS, etc. Channel deterioration is problematic since it may result in a disruption of communication between the MS and the BS. For example, when the MS is located inside a structure, such as an office building or a house, a channel between the BS and the MS may deteriorate due a shadow region that is formed by the building. A shadow region formed within a building will hereafter be referred to as an indoor shadow region. The MS located in the indoor shadow region may not be able to adequately perform communication with the BS.

Recently, a Femtocell concept is proposed in order to provide a high level of data service to users while addressing a service limitation of an indoor shadow region. The Femtocell concept will be explained in further detail below with reference to FIG. 1.

FIG. 1 is a view illustrating a wireless communication system including a Femtocell according to the conventional art.

Referring to FIG. 1, the Femtocell is a small cell coverage area that is serviced by a Femtocell BS (FBS) that accesses a wireless communication Core Network (CN) via a broadband network. The FBS may be installed inside or adjacent to an indoor space to which it is intended to provide service. Since the Femtocell is a very small cell coverage area compared to a macro cell coverage area, a plurality of Femtocells may exist within one macro cell.

Unlike macro BSs, FBSs may be purchased and installed by a subscriber for use in conjunction with the wireless communication system. Here, the subscriber may desire to limit access to the FBS and only provide access to authorized MSs. To facilitate this arrangement, a Closed Subscriber Group (CSG) FBS may be employed. A CSG FBS may only provide access to authorized MSs, except for emergency services and National Security/Emergency Preparedness (NS/EP) services.

In operation, when a signal is received by an MS from a BS, the MS determines whether the BS is a macro BS or an FBS. Also, if the BS is an FBS, the MS determines whether the FBS is an FBS that may be accessed by the MS. Such identification of a BS may be achieved through an identifier included in a system information message.

Similar to macro BSs, FBSs may be configured to optimize their operation in a given environment. One of the more important parameters of an FBS to configure is transmission power of the FBS. However, there are many challenges to properly configuring the transmission power of the FBS. The difficulty in configuring the transmission power of the FBS stems from the significant variations in the radio propagation environment in which Femtocell BSs are disposed. For example, FBSs may be installed within structures of differing sizes and constructions. For example, the structure may be an apartment, a townhouse, a single-family house, etc. The structure may have one floor or multiple floors and a basement. Moreover, the structure may be constructed of brick, concrete, glass, etc. Further, it may be expected that coverage area of the Femtocell is to include an area outside the structure. In such cases, the size of the area outside the structure and the inclusion or absence of objects within the area, such as trees, varies the transmission power requirements of the FBS.

In addition, when multiple FBSs are located near each other, inter-Femtocell interference may occur. For example, in an apartment building environment, where people on different floors or neighbors on the same floor install Femtocell BSs, interference from a neighboring FBS may be experienced. In another example, in a house community environment, where people in different neighboring houses install the FBSs, interference from a neighboring FBS may be experienced.

Generally, there are two techniques for configuring the transmission power of an FBS. The first technique is on-site professional configuration and the second technique is autonomous configuration. On-site professional configuration provides a precise configuration, but it has a high cost. Further, re-configuration may need to be performed if the environment changes. Autonomous configuration provides plug-and-play operation and thus is cost-effective. However, when autonomous configuration is performed, inter-Femtocell interference is more likely to occur.

An MS operating in a wireless communication system that includes CSG FBSs may experience the following situation. An MS located in a service coverage area of an FBS the MS is authorized to receive service from becomes overwhelmed by interference from a neighboring FBS. Due to the interference, the MS losses its connection with the FBS or is unable to detect the FBS. Here, the MS cannot access the neighboring FBS because the neighboring FBS is a CSG FBS and therefore does not allow access to an unauthorized MS, except for an emergency service. Therefore, the MS falls into a black hole in the network, even though the MS is located within the service coverage area of the FBS it is authorized to receive service from. To make the situation even worse, the MS is prohibited from sending any signal to the neighboring FBS since the neighboring FBS is a CSG FBS.

Therefore, a need exists for a technique for mitigating interference in a wireless communication system.

### SUMMARY OF THE INVENTION

An aspect of the present invention is to address at least the above-mentioned problems and/or disadvantages and to provide at least the advantages described below. Accordingly, an aspect of the present invention is to provide a technique for mitigating interference in a wireless communication system.

Another aspect of the present invention is to provide a technique for interference mitigation using Mobile Station (MS) signaling in a wireless communication system.

Yet another aspect of the present invention is to provide a technique for autonomous interference mitigation among neighboring Femtocell Base Stations (FBSs).

In accordance with an aspect of the present invention, a method for operating an MS for Interference Mitigation (IM) in a wireless communication system including a plurality of Closed Subscriber Group (CSG) FBSs is provided. The method includes determining if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from, and if it is determined that the MS cannot access the first CSG FBS due to interference received from the second CSG FBS, transmitting an IM-Signal to the second CSG FBS requesting that the second CSG FBS mitigate the interference to the MS.

In accordance with yet another aspect of the present invention, a method for operating a CSG FBS for IM in a wireless communication system is provided. The method includes receiving an IM-Signal from a Mobile Station (MS), wherein the MS is not authorized to receive service from the CSG FBS, and adjusting radio resources of the CSG FBS to mitigate interference to the MS based on the received IM-Signal.

In accordance with still another aspect of the present invention, an MS for IM in a wireless communication system including a plurality of CSG FBSs is provided. The MS includes a receiver for receiving signals from at least one CSG FBS, a transmitter for transmitting signals to at least one CSG FBS, and a controller. The controller controls the receiver and transmitter, and determines if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from, and, if it is determined that the MS cannot access the first CSG FBS due to interference received from the second CSG FBS, controls to transmit an IM-Signal to the second CSG FBS requesting that the second CSG FBS mitigate the interference to the MS.

In accordance with yet another aspect of the present invention, a CSG FBS for IM in a wireless communication system is provided. The CSG FBS includes a receiver for receiving signals from at least one MS, a transmitter for transmitting signals to at least one MS, and a controller. The controller controls the receiver and transmitter, and controls to receive an IM-Signal from a MS, wherein the MS is not authorized to receive service from the CSG FBS, and controls to adjust radio resources of the CSG FBS to mitigate interference to the MS based on the received IM-Signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a wireless communication system including a Femtocell according to the conventional art;

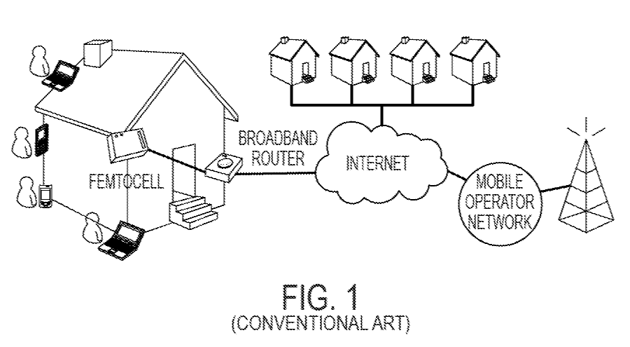

FIG. 2 is a flowchart illustrating a procedure for a Mobile Station (MS) to determine when to send an Interference Mitigation (IM)-Signal according to an exemplary embodiment of the present invention;

FIG. 3 is a flowchart illustrating a procedure for a Femtocell BS (FBS) to respond to an IM-Signal according to an exemplary embodiment of the present invention;

FIG. 4 is a signal diagram illustrating another procedure for an FBS to respond to an IM-Signal according to an exemplary embodiment of the present invention;

FIG. 5 is a block diagram illustrating an MS in a wireless communication system according to an exemplary embodiment of the present invention; and

FIG. 6 is a block diagram illustrating an FBS in a wireless communication system according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to a technique for mitigating in a wireless communication system. More specifically, exemplary embodiments of the present invention described below relate to a technique for interference mitigation using Mobile Station (MS) signaling in a wireless communication system. In addition, exemplary embodiments of the present invention described below relate to a technique for autonomous interference mitigation among neighboring Femtocell Base Stations (FBSs).

It should be understood that the following description might refer to terms utilized in various standards merely for simplicity of explanation. For example, the following description may refer to terms utilized in the Institute of Electrical and Electronics Engineers (IEEE) 802.16m standard or the 3^{rd} Generation Partnership Project (3GPP) Long Term Evolution (LTE) standard. However, this description should not be interpreted as being limited to the IEEE 802.16m or 3GPP LTE standards. Independent of the mechanism used for interference mitigation, it is preferable to mitigate interference and it is advantageous for that ability to conform to a standardized mechanism.

Exemplary embodiments of the present invention will be described in the context of a wireless communication system that includes two adjacent FBSs and an MS that is authorized to be serviced by one of the FBSs. For ease in explanation, the two adjacent FBSs will be referred to as FBS-A and FBS-B, respectively. Here, FBS-A denotes an FBS serving the MS and FBS-B denotes an interfering FBS. While two FBSs, namely FBS-A and FBS-B, are described herein, the present invention is not limited to two FBSs and any number of FBSs may be deployed. Further, any FBS may operate in the role of and include the capabilities of at least one of FBS-A and FBS-B. Still further, while at least one FBS-B is a Closed Subscriber Group (CSG) FBS, any number of FBSs may be a CSG FBS. In addition, since it is assumed herein that the MS is authorized to be serviced by FBS-A, the MS will be referred to as MS-A. While one MS is described herein, the present invention is not limited to one MS and any number of MSs may be deployed with each MS being authorized to be serviced by one or more FBSs. In addition, the service coverage area of at least one of FBS-A and FBS-B may be within the service coverage area of a wireless communication system, such as a wireless communication system operating according to the IEEE 802.16m or 3GPP LTE standards. Also, at least one of FBS-A and FBS-B may communicate with a Core Network (CN) of a wireless communication system, such as a wireless communication system operating according to the IEEE 802.16m or 3GPP LTE standards.

Exemplary embodiments of the present invention address the scenario where MS-A, which is being serviced by FBS-A, becomes overwhelmed by interference from FBS-B, a neighboring FBS, and as a result, at least one of losses its connection with and cannot detect FBS-A. Here, MS-A cannot access FBS-B since FBS-B is a CSG FBS and MS-A is not authorized to be serviced by FBS-B, except for an emergency service and National Security/Emergency Preparedness (NS/EP) services. As a result, MS-A is unable to receive service from either FBS-A or FBS-B. Described hereafter are techniques to address this scenario.

In an exemplary embodiment of the present intention, when MS-A is overwhelmed by interference from FBS-B and is unable to at least one of access and detect FBS-A, MS-A may transmit an Interference Mitigation (IM)-Signal to FBS-B to request that FBS-B mitigate interference experienced by MS-A. The mitigation of the interference by FBS-B may occur automatically in response to the IM-Signal transmitted by MS-A. Here, MS-A may transmit the IM-Signal directly to FBS-B despite MS-A not being authorized to access FBS-B for regular traffic service. In an alternative exemplary embodiment, MS-A may communicate the IM-Signal to FBS-B via a wireless communication system, such as a wireless communication system operating according to the IEEE 802.16m or 3GPP LTE standards.

The IM-Signal transmitted by MS-A to FBS-B may be a special ranging code used only for MS-A (a non-authorized MS) to send IM signaling, which may not be used by MS-A for other purposes such as regular network (re-)entry, periodic ranging, handover ranging etc. The special ranging code may use one of the transmission opportunities (TXOP) of a ranging code. The indexes of the reserved codes may be broadcast over the air by FBS-B in an information block, or provided to MS-A through profiles or other relevant specifications. The ranging codes may be common to all FBSs and MSs in a wireless communication system. Alternatively, the ranging codes may be unique to one or more FBSs and/or MSs.

FBS-B may determine whether it will adjust its own radio resources. If FBS-B determines to adjust its own radio resources, FBS-B may then determine how it adjusts its own radio resources. In this case, FBS-B may be better able to avoid being abused by a rogue MS, and avoid unnecessarily sacrificing service in its own Femtocell. In addition, FBS-B may request more information from MS-A, such as the location of MS-A, the signal strength of FBS-B received by MS-A at that location, etc. In this case, FBS-B may adjust its radio resources to mitigate the interference experienced by MS-A, and at the same time, minimize the impact to its own Femtocell of the interference mitigation.

FBS-B may adjust its radio resources for interference mitigation in any of a number of ways. Examples of how FBS-B may adjust its radio resources for interference mitigation include one or more of adjusting omni-directional transmission power, adjusting antenna radiation direction to reduce interference while enhancing signal strength in its own Femtocell, sharing radio resources with one or more neighboring FBSs using Fractional Frequency Reuse (FFR) or Time Division Multiplexing (TDM)), frequency hopping, etc. While specific examples of how the FBS-B may adjust its radio resources for interference mitigation has been provided herein, the present invention is not limited thereto and any other adjustment to radio resources may be employed.

The determination by MS-A to transmit the IM-Signal will be discussed in greater detail below. Herein, MS-A should not transmit an IM-Signal to FBS-B unless it is appropriate to do so. For example, MS-A should not transmit an IM-Signal to FBS-B while the ability to be serviced by FBS-A is maintained. However, when the ability to be serviced by FBS-A cannot be maintained and MS-A has at least one of lost its connection with and cannot detect FBS-A, MS-A should evaluate whether the disruption in the ability to service MS-A was lost because of the overwhelming interference from FBS-B.

MS-A should be serviced by FBS-A if it is within the service coverage area of FBS-A. Thus, MS-A should evaluate whether it is still within the service coverage area of FBS-A. For example, if MS-A is outside the service coverage area of FBS-A, MS-A should not send an IM-Signal to FBS-B. The location of MS-A may be determined by any location determination technique, such as triangulation, the use of a Global Positioning System (GPS), etc.

In addition, MS-A should not transmit the IM-Signal to FBS-B unless a signal received from FBS-B is above a pre-specified interference threshold, hereafter referred to as I threshold. Furthermore, MS-A should not attempt to send the IM-signal at a given location on a giving carrier for more than a pre-specified threshold number of times, hereafter referred to as Num threshold.

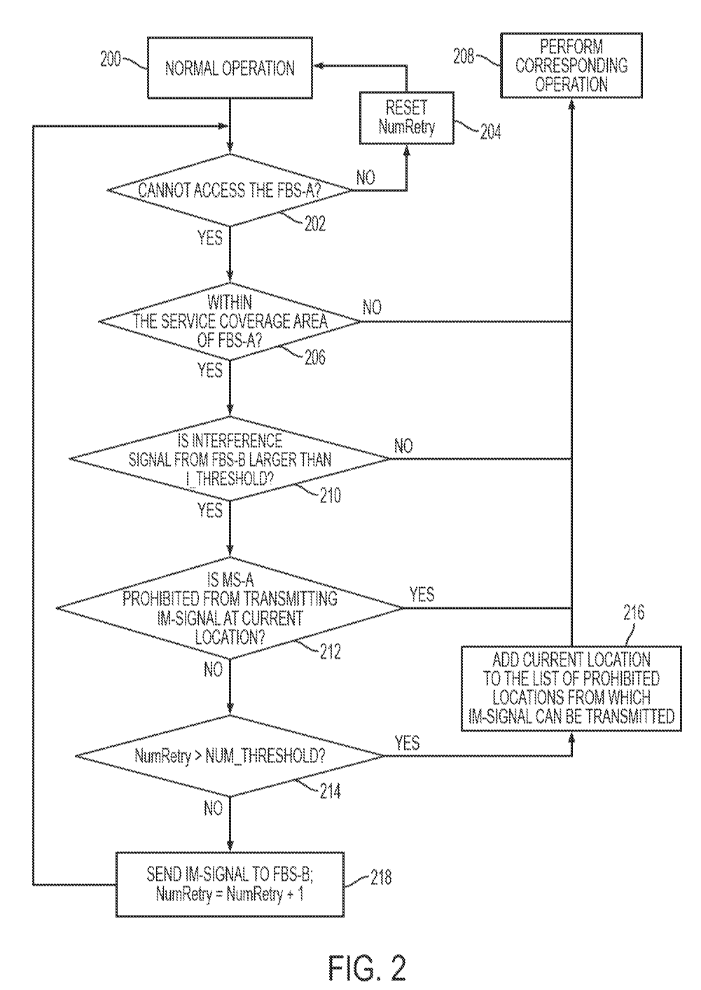

By having MS-A only transmit the IM-Signal to FBS-B when it has been determined that transmission of the IM-Signal is appropriate, disruption to the normal service of FBS-B is minimized. A procedure for MS-A to determine when to send an IM-Signal to FBS-B according to an exemplary embodiment of the present invention is described below with reference to FIG. 2.

FIG. 2 is a flowchart illustrating a procedure for an MS to determine when to send an IM-Signal according to an exemplary embodiment of the present invention.

Referring to FIG. 2, in step 200, MS-A performs a normal operation with FBS-A. That is, MS-A is serviced by FBS-A and can access FBS-A. In step 202, MS-A determines if it cannot access FBS-A. Here, if MS-A is able to access FBS-A, MS-A proceeds to step 204 and resets a counter (NumRetry) that tracks the number of attempts by MS-A to reconnect to FBS-A. Thereafter, MS-A returns to step 200. If MS-A determines that it cannot access FBS-A at step 202, MS-A determines if it is within the service coverage area of FBS-A in step 206. If MS-A determines that it is not with the service coverage area of FBS-A at step 206, MS-A completes the procedure and performs a corresponding operation in step 208, such as continuing scanning for macro and other BSs that MS-A could at least one of access. If MS-A determines that it is within the service coverage area of FBS-A at step 206, MS-A determines if the interference signal received from FBS-B is larger that an interference threshold (I threshold) in step 210. If MS-A determines than the interference signal received from FBS-B is not larger than I_threshold at step 210, MS-A completes the procedure and performs a corresponding operation in step 208, such as continuing scanning for macro and other BSs that MS-A could at least one of access. If MS-A determines that the interference signal received from FBS-B is larger than I threshold at step 210, MS-A determines if it is prohibited from transmitting an IM-Signal at its current location in step 212. MS-A may further determine if it is prohibited from transmitting an IM-Signal at its current location for a given carrier. MS-A may determine if it is prohibited from transmitting an IM-Signal based on a list stored in a memory of MS-A. If MS-A determines that it is prohibited from transmitting an IM-Signal at its current location at step 212, MS-A completes the procedure and performs a corresponding operation in step 208, such as continuing scanning for macro and other BSs that MS-A could at least one of access. If MS-A determines that it is not already prohibited from transmitting an IM-Signal at its current location at step 212, MS-A determines if NumRetry is greater than a threshold (Num threshold) in step 214. If MS-A determines that NumRetry is greater than Num threshold at step 214, MS-A adds the current location to the list of locations it is prohibited from sending the IM-Signal. Thereafter, MS-A completes the procedure and performs a corresponding operation in step 208, such as continuing scanning for macro and other BSs that MS-A could at least one of access. If MS-A determines that NumRetry is not greater than Num threshold at step 214, MS-A transmits the IM-Signal to FBS-B and increments NumRetry by one in step 218. Thereafter, MS-A returns to step 202.

Any number of steps 204, 206, 210, 212, 214, and 216 may be omitted. When step 204 is omitted, the procedure proceeds to step 200 from step 202. When step 206 is omitted, the procedure proceeds to the next of steps 210, 212, 214 and 218. When step 210 is omitted, the procedure proceeds to the next of steps 212, 214, and 218. When step 212 is omitted, the procedure proceeds to the next of steps 214 and 218. When step 214 is omitted, the procedure proceeds to step 218. When step 216 is omitted, the procedure proceeds to step 208. When step 214 is omitted, step 204 may also be omitted. In addition, any number of steps 206, 210, 212 and 214 may be arranged in a different order. However, when any number of steps 206, 210, 212 and 214 are arranged in a different order, only step 214 should proceed to step 216. However, the procedure described above with reference to FIG. 2 does not address the situation of a rogue MS-A that might abuse the sending of an IM-Signal to disrupt the normal service of FBS-B. To address this concern, FBS-B may control whether to respond to IM-Signals received from MS-A, and how to adjust radio resources.

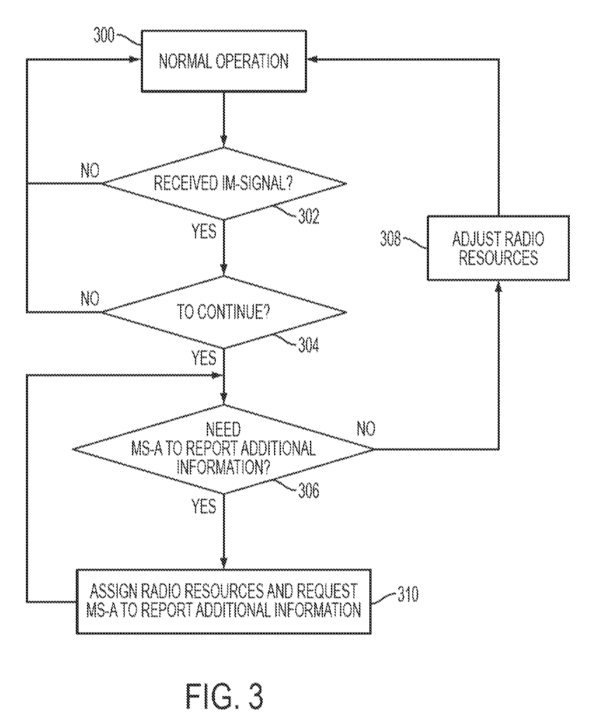

An exemplary embodiment of the present invention that addresses the concern that a rogue MS might abuse the sending of an IM-Signal to disrupt the normal service of an FBS-B is described below with reference to FIG. 3.

FIG. 3 is a flowchart illustrating a procedure for an FBS to respond to an IM-Signal according to an exemplary embodiment of the present invention.

Referring to FIG. 3, in step 300 FBS-B performs a normal operation. In step 302, FBS-B determines if it receives an IM-Signal from MS-A. If FBS-B determines that it did not receive an IM-Signal from MS-A at step 302, FBS-B returns to step 300. If FBS-B determines that it did receive an IM-Signal from MS-A at step 302, FBS-B determines if it is to continue to process the received IM-Signal in step 304. FBS-B may ignore any IM-Signal depending on manufacture settings, configuration by the FBS-B owner, remote configuration by the core network, etc. However, if FBS-B determines that it is to continue to process the received IM-Signal at step 304 as a configuration of ad hoc interference mitigation among Femtocell neighbors, FBS-B determines if it needs additional information from MS-A, such as identity information, location and/or other information from MS-A in step 306. If FBS-B determines that it does not need additional information from MS-A at step 306, FBS-B adjusts its radio resources in step 308. Thereafter, FBS-B returns to step 300. If FBS-B determines that it needs additional information from MS-A at step 306, FBS-B assigns resources to MS-A and requests MS-A to report its location, a security certificate, and/or other information in step 310. Thereafter, FBS-B returns to step 306.

Step 304 or steps 306 and 310 may be omitted. When step 304 is omitted, the procedure proceeds to step 306 from step 302. When steps 306 and 310 are omitted, the procedure proceeds to step 308. In addition, step 304 and steps 306 and 310 may be arranged in a different order. When arranged in a different order, the procedure proceeds to step 306 from step 302 and step 304 is disposed between step 306 and step 308. However, the procedure described above with reference to FIG. 3, may not enable the FBS-B to verify if MS-A is legitimate. To address this situation, the FBS-B may contact at least one of a CN and FBS-A in order to validate whether MS-A is a legitimate MS in this neighborhood, and whether MS-A′s request for interference mitigation is a legitimate requirement.

Having received the request from FBS-B for validating MS-A's requirement for interference mitigation, the CN may check which FBSs MS-A is authorized to access, and identify the FBSs MS-A is authorized to access (i.e., FBS-A). Optionally, both the CN and FBS-B could request FBS-A to confirm that MS-A is experiencing interference from FBS-B. Having received those requests, FBS-A could validate MS-A's situation, for example by paging MS-A.

Based on this evaluation, the CN could confirm to FBS-B that the request from MS-A is legitimate. Then FBS-B could adjust its radio resources, e.g., using a different carrier, TDM/FDM, power control, etc.

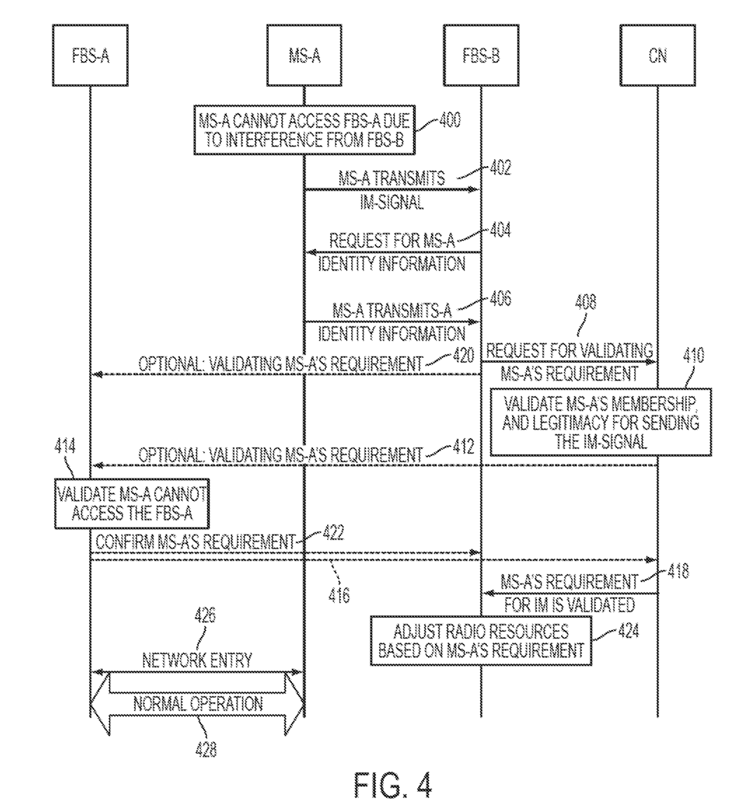

An exemplary embodiment of the present invention that enables FBS-B to verify if MS-A's requirement is legitimate is described below with reference to FIG. 4.

FIG. 4 is a signal diagram illustrating another procedure for an FBS to receive an IM-Signal according to an exemplary embodiment of the present invention.

Referring to FIG. 4, in step 400 MS-A detects interference from FBS-B. In response, MS-A transmits an IM-Signal to FBS-B in step 402. Herein, step 402 may automatically proceed after step 400 or may be performed according to the procedure described above with respect to FIG. 2. In response to the IM-Signal received from MS-A, FBS-B may transmit to MS-A a request for MS-A's identity information in step 404. In response, MS-A may transmit its identity information to FBS-B in step 406. In an exemplary implementation, instead of step 404 and 406 being performed, MS-A may include its identity information with the IM-Signal transmitted at step 402.

Herein, the FBS-B should validate MS-A's requirement with at least one of FBS-A and a CN, such as the CN of a wireless communication system operating according to the IEEE 802.16m or 3GPP LTE standards. The validation of MS-A's requirement may be validation whether MS-A is a legitimate MS in an area FBS-B is located in, and/or whether the MS-A's request for IM is a legitimate requirement. To validate MS-A's requirement with the CN, FBS-B transmits a request for validating MS-A's requirement to the CN in step 408. In step 410 the CN validates MS-A's membership, and/or MS-A's legitimacy for transmitting the IM-Signal. Optionally, in step 412, the CN transmits a message to FBS-A requesting validation of MS-A's requirement. In response, FBS-A validates that MS-A cannot access FBS-A in step 414 and transmits a message to the CN confirming MS-A's requirement in step 416. In step 418, the CN transmits a message to FBS-B indicating that MS-A's requirement is validated.

To validate MS-A's requirement with FBS-A, FBS-B transmits a message to FBS-A requesting validation of MS-A's requirement in step 420. In response, FBS-A validates that MS-A is authorized by FBS-A and/or cannot access FBS-A in step 414 and transmits a message to FBS-B confirming MS-A's requirement in step 422.

Once MS-A's requirement has been validated, FBS-B adjusts its radio resources based on MS-A's requirement to mitigate the interference to MS-A in step 424. If the interference to MS-A has not been sufficiently mitigated, MS-A may repeat the procedure beginning at step 400. However, if the interference to MS-A has been sufficiently mitigated, MS-A reestablishes the connection to FBS-A in step 426 and resumes a normal operation in step 428.

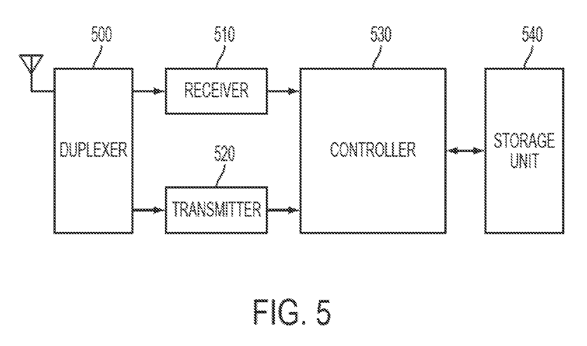

FIG. 5 is a block diagram illustrating an MS in a wireless communication system according to an exemplary embodiment of the present invention.

Referring to FIG. 5, MS-A includes a duplexer 500, a receiver 510, a transmitter 520, a controller 530, and a storage unit 540. The MS-A may include any number of additional structural elements. However, a description of additional structural elements of the MS-A is omitted for conciseness.

The duplexer 500 transmits a transmission signal provided from the transmitter 520 via an antenna, and provides a reception signal from the antenna to the receiver 510 according to a duplexing scheme.

The receiver 510 converts the reception signal provided from the duplexer 500 into a baseband signal, and provides the baseband signal to the controller 530. For example, when the wireless communication system uses an Orthogonal Frequency Division Multiplexing (OFDM) scheme, the receiver 510 includes a Radio Frequency (RF) processor, an Analog/Digital Converter (ADC), an OFDM demodulator, and a decoder. Accordingly, the RF processor converts an RF signal provided from the duplexer 500 into a baseband analog signal. The ADC converts the analog signal provided from the RF processor into digital sample data. The OFDM demodulator transforms sample data in a time domain provided from the ADC into data in a frequency domain by performing a Fast Fourier Transform (FFT). The decoder demodulates and decodes a signal provided from the OFDM demodulator according to a Modulation and Coding Scheme (MCS) level.

The controller 530 controls overall operations of MS-A. The operations of MS-A include any of the operations explicitly or implicitly described above as being performed by MS-A. For example, the controller 530 may determine if MS-A cannot access FBS-A due to interference from FBS-B, and if it is determined that MS-A cannot access FBS-A due to interference received from FBS-B, control to transmit an IM-Signal via duplexer 500 and transmitter 520 to FBS-B to request that FBS-B mitigate the interference to MS-A.

The transmitter 520 converts a transmission signal into an RF signal, and provides the RF signal to the duplexer 500 under control of the controller 530. For example, when the wireless communication system uses an OFDM scheme, the transmitter 520 includes an encoder, an OFDM modulator, a Digital/Analog Converter (DAC) and an RF processor. The encoder encodes and modulates a transmission signal according to an MCS level under control of the controller 530. The OFDM modulator converts data in the frequency domain provided from the encoder into sample data (i.e., an OFDM symbol) in a time domain by performing an Inverse FFT (IFFT). The DAC converts sample data provided from the OFDM modulator into an analog signal. The RF processor converts a baseband analog signal provided from the DAC into an RF signal.

The storage unit 540 stores programs required for overall operations of the UE and various data, such as the list of prohibited locations from which an IM-Signal can be transmitted. Also, the storage unit 540 may store information on one or more FBSs that MS-A is authorized to receive service from. In addition, the storage unit 540 may store information of the ranging codes it my use to transmit an IM-Signal.

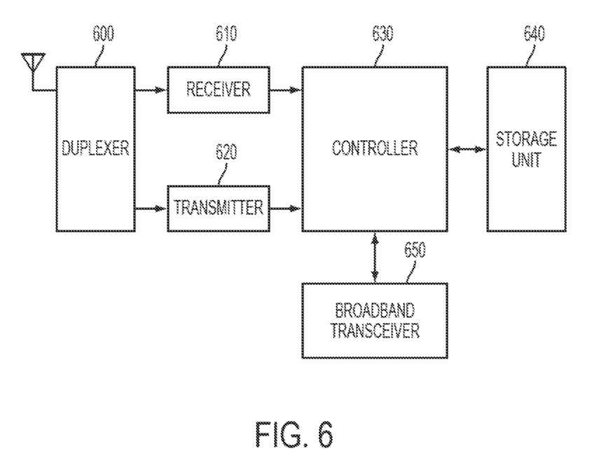

FIG. 6 is a block diagram illustrating an FBS in a wireless communication system according to an exemplary embodiment of the present invention.

Referring to FIG. 6, the FBS-B includes a duplexer 600, a receiver 610, a transmitter 620, a controller 630, a storage unit 640, and a broadband transceiver 650. FBS-B may include any number of additional structural elements. However, a description of additional structural elements of FBS-B is omitted for conciseness.

The duplexer 600 transmits a transmission signal provided from the transmitter 620 via an antenna, and provides a reception signal from the antenna to the receiver 610 according to a duplexing scheme.

The receiver 610 converts a reception signal provided from the duplexer 600 into a baseband signal and provides the baseband signal to the controller 630. For example, when the wireless communication system uses an OFDM scheme, the receiver 610 includes an RF processor, an ADC, an OFDM demodulator and a decoder. The RF processor converts an RF signal provided from the duplexer 600 into a baseband analog signal. The ADC converts the analog signal provided from the RF processor into digital sample data. The OFDM demodulator converts sample data in the time domain provided from the ADC into data in the frequency domain by performing FFT. The decoder demodulates and decodes a signal provided from the OFDM demodulator according to an MCS level.

The controller 630 controls overall operations of FBS-B. The operations of FBS-B include any of the operations explicitly or implicitly described above as being performed by FBS-B. For example, the controller 630 may control to receive via duplexer 600 and receiver 610 an IM-Signal from MS-A, and adjust its radio resources to mitigate interference to MS-A based on the received IM-Signal.

The transmitter 620 converts a transmission signal into an RF signal and provides the RF signal to the duplexer 600 under control of the controller 630. For example, when the wireless communication system uses an OFDM scheme, the transmitter 620 includes an encoder, an OFDM modulator, a Digital/Analog Converter (DAC) and an RF processor. The encoder encodes and modulates a transmission signal according to an MCS level under control of the controller 630. The OFDM modulator converts data in the frequency domain provided from the encoder to sample data (i.e., an OFDM symbol) in the time domain by performing IFFT. The DAC converts sample data provided from the OFDM modulator into an analog signal. The RF processor converts a baseband analog signal provided from the DAC into an RF signal.

The storage unit 640 stores programs required for overall operations of the UE and various data.

The broadband transceiver 650 facilities communication with at least one of other FBSs and a CN of a wireless communication system, such as a wireless communication system operating according to the IEEE 802.16m or 3GPP LTE standards.

Exemplary embodiments of the present invention allow neighboring FBSs to adjust their radio resources and realize interference mitigation autonomously. This makes it possible to design plug-and-play FBSs. It also reduces the cost for an operator by removing or reducing the necessity for professional installation of FBSs in subscribers' houses.

Exemplary embodiments of the present invention allow an MS to signal a neighbor CSG FBS. At the same time, the CSG FBS does not have to allow the MS to access for data traffic.

Exemplary embodiments of the present invention also set forth procedures for an MS to send an IM-Signal only when it is appropriate, and protect a CSG FBS from hostile interruption from rogue MSs.

Certain aspects of the present invention may also be embodied as computer readable code on a computer readable recording medium. A computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a Mobile Station (MS) for Interference Mitigation (IM) in a wireless communication system including a plurality of Closed Subscriber Group (CSG) Femtocell Base Stations (FBSs), the method comprising:
determining if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from; and
if it is determined that the MS cannot access the first CSG FBS due to interference received from the second CSG FBS, transmitting an IM-Signal to the second CSG FBS requesting that the second CSG FBS mitigate the interference to the MS.

2. The method of claim 1, wherein the MS transmits the IM-Signal to the second CSG FBS if it is determined that the MS cannot access the first CSG FBS due to interference received from the second CSG FBS and if it is determined that the MS is located within the service coverage area of the first CSG FBS.

3. The method of claim 1, wherein the MS transmits the IM-Signal to the second CSG FBS if it is determined that the MS cannot access the first CSG FBS due to interference received from the second CSG FBS and if it is determined that the interference received from the second CSG FBS is greater than a threshold.

4. The method of claim 1, wherein the MS transmits the IM-Signal to the second CSG FBS if it is determined that the MS cannot access the first CSG FBS due to interference received from the second CSG FBS and if it is determined that the MS is not prohibited from transmitting the IM-Signal at its current location.

5. The method of claim 1, wherein the MS transmits the IM-Signal to the second CSG FBS if it is determined that the MS cannot access the first CSG FBS due to interference received from the second CSG FBS and if it is determined that the number of times the IM-Signal has been transmitted to the second CSG FBS without being able to access the first CSG FBS is less than or equal to a threshold.

6. The method of claim 5, wherein if it is determined that the number of times the IM-Signal has been transmitted to the second CSG FBS without being able to access the first CSG FBS is greater than the threshold, the current location is added to a list of locations the MS is prohibited from transmitting an IM-Signal to the second CSG FBS.

7. The method of claim 1, further comprising:
receiving a request for information from the second CSG FBS in response to the IM-Signal; and
transmitting the requested information to the second CSG FBS.

8. The method of claim 7, wherein the information includes at least one of identity information, a security certificate, location information and signal strength of the interference.

9. The method of claim 1, wherein the IM-Signal is transmitted to the second CSG FBS via a ranging code that is reserved for transmission of the IM-Signal.

10. The method of claim 9, wherein the ranging code is received from the second CSG FBS.

11. A method for operating a Closed Subscriber Group (CSG) Femtocell Base Station (FBS) for Interference Mitigation (IM) in a wireless communication system, the method comprising:
receiving an IM-Signal from a Mobile Station (MS), wherein the MS is not authorized to receive service from the CSG FBS; and
adjusting radio resources of the CSG FBS to mitigate interference to the MS based on the received IM-Signal.

12. The method of claim 11, further comprising:
requesting additional information from the MS; and
receiving the requested additional information from the MS.

13. The method of claim 12, wherein the information includes at least one of identity information, a security certificate, location information and signal strength of an interference signal received by the MS.

14. The method of claim 11, further comprising:
requesting validation of the MS's request for IM from a Core Network (CN) of the wireless communication system; and
receiving validation of the MS's request for IM from the CN.

15. The method of claim 14, wherein the validation of the MS's request for IM is one of validation whether the MS is a legitimate MS in an area the FBS is located in and validation whether the MS's request for IM is legitimate.

16. The method of claim 11, further comprising:
requesting validation of the MS's request for IM from another CSG FBS, wherein the other CSG FBS is authorized to provide service to the MS; and
receiving validation of the MS's request for IM from the other CSG FBS.

17. The method of claim 16, wherein the validation of the MS's request for IM is one of validation whether the MS is a legitimate MS in an area the FBS is located in and validation whether the MS's request for IM is legitimate.

18. The method of claim 11, wherein the CSG FBS adjusts radio resources to mitigate interference to the MS by employing at least one of adjusting omni-directional transmission power, adjusting antenna radiation direction, sharing radio resources with one or more neighboring CSG FBSs using Fractional Frequency Reuse (FFR) or Time Division Multiplexing (TDM)), and frequency hopping.

19. The method of claim 11, wherein the CSG FBS adjusts radio resources to mitigate interference to the MS and to minimize the impact of the adjustments to the radio resources within its own service coverage area.

20. The method of claim 11, further comprising:
transmitting at least one reserved code reserved for IM-Signaling,
wherein the IM-Signal is received from the MS using one of the a least one reserved code.

21. A Mobile Station (MS) for Interference Mitigation (IM) in a wireless communication system including a plurality of Closed Subscriber Group (CSG) Femtocell Base Stations (FBSs), the MS comprising:
a receiver for receiving signals from at least one CSG FBS;
a transmitter for transmitting signals to at least one CSG FBS; and
a controller that controls the receiver and transmitter, and determines if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from, and, if it is determined that the MS cannot access the first CSG FBS due to interference received from the second CSG FBS, controls to transmit an IM-Signal to the second CSG FBS requesting that the second CSG FBS mitigate the interference to the MS.

22. The MS of claim 21, wherein, if it is determined by the controller that the MS cannot access the first CSG FBS due to interference received from the second CSG FBS and if it is determined by the controller that the MS is located within the service coverage area of the first CSG FBS, the controller controls to transmit an IM-Signal to the second CSG FBS requesting that the second CSG FBS mitigate the interference to the MS.

23. The MS of claim 21, wherein, if it is determined by the controller that the MS cannot access the first CSG FBS due to interference received from the second CSG FBS and if it is determined by the controller that the interference received from the second CSG FBS is greater than a threshold, the controller controls to transmit an IM-Signal to the second CSG FBS requesting that the second CSG FBS mitigate the interference to the MS.

24. The MS of claim 21, wherein, if it is determined by the controller that the MS cannot access the first CSG FBS due to interference received from the second CSG FBS and if it is determined by the controller that the MS is not prohibited from transmitting the IM-Signal at its current location, the controller controls to transmit an IM-Signal to the second CSG FBS requesting that the second CSG FBS mitigate the interference to the MS.

25. The MS of claim 21, wherein, if it is determined by the controller that the MS cannot access the first CSG FBS due to interference received from the second CSG FBS and if it is determined by the controller that the number of times the IM-Signal has been transmitted to the second CSG FBS without being able to access the first CSG FBS is less than or equal to a threshold, the controller controls to transmit an IM-Signal to the second CSG FBS requesting that the second CSG FBS mitigate the interference to the MS.

26. The MS of claim 25, wherein if it is determined by the controller that the number of times the IM-Signal has been transmitted to the second CSG FBS without being able to access the first CSG FBS is greater than the threshold, the controller adds the current location to a list of locations the MS is prohibited from transmitting an IM-Signal to the second CSG FBS.

27. The MS of claim 21, wherein the controller controls to receive a request for information from the second CSG FBS in response to the IM-Signal and transmit the requested information to the second CSG FBS.

28. The MS of claim 27, wherein the information includes at least one of identity information, a security certificate, location information and signal strength of the interference.

29. The method of claim 21, wherein the IM-Signal is transmitted to the second CSG FBS via a ranging code that is reserved for transmission of the IM-Signal.

30. The method of claim 29, wherein the ranging code is received from the second CSG FBS.

31. A Closed Subscriber Group (CSG) Femtocell Base Station (FBS) for Interference Mitigation (IM) in a wireless communication system, the CSG FBS comprising:
a receiver for receiving signals from at least one Mobile Station (MS);
a transmitter for transmitting signals to at least one MS; and
a controller that controls the receiver and transmitter, and controls to receive an IM-Signal from a MS, wherein the MS is not authorized to receive service from the CSG FBS, and for controlling to adjust radio resources of the CSG FBS to mitigate interference to the MS based on the received IM-Signal.

32. The CSG FBS of claim 31, wherein the controller controls to request additional information from the MS and receive the requested additional information from the MS.

33. The CSG FBS of claim 32, wherein the information includes at least one of identity information, a security certificate, location information and signal strength of an interference signal received by the MS.

34. The CSG FBS of claim 31, further comprising a broadband transceiver for communicating information with a Core Network (CN) of the wireless communication system,
wherein the controller controls the broadband transceiver and controls to request validation of the MS's request for IM from the CN and to receive validation of the MS's request for IM from the CN.

35. The method of claim 34, wherein the validation of the MS's request for IM is one of validation whether the MS is a legitimate MS in an area the FBS is located in and validation whether the MS's request for IM is legitimate.

36. The CSG FBS of claim 31, wherein the controller controls to request validation of the MS's request for IM from another CSG FBS that is authorized to provide service to the MS and to receive validation of the MS's request for IM from the other CSG FBS.

37. The method of claim 36, wherein the validation of the MS's request for IM is one of validation whether the MS is a legitimate MS in an area the FBS is located in and validation whether the MS's request for IM is legitimate.

38. The CSG FBS of claim 31, wherein the controller controls to adjust radio resources to mitigate interference to the MS by employing at least one of adjusting omni-directional transmission power, adjusting antenna radiation direction, sharing radio resources with one or more neighboring CSG FBSs using Fractional Frequency Reuse (FFR) or Time Division Multiplexing (TDM)), and frequency hopping.

39. The CSG FBS of claim 31, wherein the controller controls to adjust radio resources to mitigate interference to the MS and to minimize the impact of the adjustments to the radio resources within its own service coverage area.

40. The method of claim 31, further comprising:
transmitting at least one reserved code reserved for IM-Signaling,
wherein the IM-Signal is received from the MS using one of the a least one reserved code.

41. A method for operating a Mobile Station (MS) for Interference Mitigation (IM) in a wireless communication system including a plurality of Closed Subscriber Group (CSG) Femtocell Base Stations (FBSs), the method comprising:
determining if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from;
determining if the MS is located within the service coverage area of the first CSG FBS;
determining if the interference received from the second CSG FBS is greater than a first threshold;
determining if the MS is not prohibited from transmitting the IM-Signal at its current location;
determining if the number of times the IM-Signal has been transmitted to the second CSG FBS without being able to access the first CSG FBS is less than or equal to a second threshold; and
transmitting an IM-Signal to the second CSG FBS requesting that the second CSG FBS mitigate the interference to the MS, if it is determined that:
the MS cannot access the first CSG FBS due to interference received from the second CSG FBS,
the MS is located within the service coverage area of the first CSG FBS, that the interference received from the second CSG FBS is greater than the first threshold,
the MS is not prohibited from transmitting the IM-Signal at its current location, and
the number of times the IM-Signal has been transmitted to the second CSG FBS without being able to access the first CSG FBS is less than or equal to the second threshold.

42. The method of claim 41, wherein if it is determined that the number of times the IM-Signal has been transmitted to the second CSG FBS without being able to access the first CSG FBS is greater than the threshold, the current location is added to a list of locations the MS is prohibited from transmitting an IM-Signal to the second CSG FBS.

43. The method of claim 41, further comprising:
receiving a request for information from the second CSG FBS in response to the IM-Signal; and
transmitting the requested information to the second CSG FBS.

44. The method of claim 43, wherein the information includes at least one of identity information, a security certificate, location information and signal strength of the interference.

45. The method of claim 41, wherein the IM-Signal is transmitted to the second CSG FBS via a ranging code that is reserved for transmission of the IM-Signal.

46. The method of claim 45, wherein the ranging code is received from the second CSG FBS.

47. A Mobile Station (MS) for Interference Mitigation (IM) in a wireless communication system including a plurality of Closed Subscriber Group (CSG) Femtocell Base Stations (FBSs), the MS comprising:
a receiver for receiving signals from at least one CSG FBS;
a transmitter for transmitting signals to at least one CSG FBS; and
a controller that controls the receiver and transmitter, and determines if the MS cannot access a first CSG FBS due to interference from a second CSG FBS, the first CSG FBS being a CSG FBS that the MS is authorized to receive service from and the second CSG FBS being a CSG FBS that the MS is not authorized to receive service from, determines if the MS is located within the service coverage area of the first CSG FBS, determines if the interference received from the second CSG FBS is greater than a first threshold, determines if the MS is not prohibited from transmitting the IM-Signal at its current location, determines if the number of times the IM-Signal has been transmitted to the second CSG FBS without being able to access the first CSG FBS is less than or equal to a second threshold, and controls to transmit an IM-Signal to the second CSG FBS requesting that the second CSG FBS mitigate the interference to the MS, if is determined that:
the MS cannot access the first CSG FBS due to interference received from the second CSG FBS,
the MS is located within the service coverage area of the first CSG FBS, that the interference received from the second CSG FBS is greater than the first threshold,
the MS is not prohibited from transmitting the IM-Signal at its current location, and
the number of times the IM-Signal has been transmitted to the second CSG FBS without being able to access the first CSG FBS is less than or equal to the second threshold.

48. The MS of claim 47, wherein if it is determined by the controller that the number of times the IM-Signal has been transmitted to the second CSG FBS without being able to access the first CSG FBS is greater than the threshold, the controller adds the current location to a list of locations the MS is prohibited from transmitting an IM-Signal to the second CSG FBS.

49. The MS of claim 47, wherein the controller controls to receive a request for information from the second CSG FBS in response to the IM-Signal and transmit the requested information to the second CSG FBS.

50. The MS of claim 49, wherein the information includes at least one of identity information, a security certificate, location information and signal strength of the interference.

51. The method of claim 47, wherein the IM-Signal is transmitted to the second CSG FBS via a ranging code that is reserved for transmission of the IM-Signal.

52. The method of claim 51, wherein the ranging code is received from the second CSG FBS.
